(19) United States
(12) Patent Application Publication
(10) Pub. No.: US 2015/0131746 A1
(43) Pub. Date: May 14, 2015

(54) SIGNAL PROCESSING DEVICE AND SIGNAL PROCESSING METHOD

(71) Applicant: Sony Corporation, Tokyo (JP)

(72) Inventors: Yuichi Hirayama, Chiba (JP); Satoshi Okada, Tokyo (JP); Sotaro Ohara, Kanagawa (JP); Yuichi Mizutani, Tokyo (JP)

(73) Assignee: Sony Corporation, Tokyo (JP)

(21) Appl. No.: 14/401,405

(22) PCT Filed: May 20, 2013
(86) PCT No.: PCT/JP2013/063930

§ 371 Date: Nov. 14, 2014

(30) Foreign Application Priority Data
May 28, 2012 (JP) 2012-120486

(51) Int. Cl. H04N 19/68; H04N 19/66

(52) U.S. Cl. CPC H04N 19/68; H04N 19/66
USPC 375/240.28

(57) ABSTRACT

Provided is a signal processing device, including a clock width calculation unit configured to calculate a clock width corresponding to a data rate of a valid section in which a transport stream (TS) packet exists, and a generation unit configured to generate a clock signal whose period is the clock width calculated in the clock width calculation unit and to output the clock signal as a shaped TS clock signal, the shaped TS clock signal being a TS clock signal of the TS packet to which shaping has been performed.

### TECHNICAL FIELD

The present technique relates to a signal processing device and a signal processing method and, in particular, for example, relates to a signal processing device and a signal processing method that enables a signal that meets specifications required by a module of a subsequent stage to be output.

### BACKGROUND ART

For example, in digital broadcasting, pictures (moving pictures) and the like are encoded with a predetermined encoding method such as Moving Picture Experts Group (MPEG) and a broadcast wave including a TS constituted by transport stream (TS) packets, which is the resulting encoded data arranged in the payload, is transmitted.

Demodulation and error correction of the broadcasting wave are performed in a receiver that receives digital broadcasting such that the TS is restored and output.

Signals that are output from a large-scale integration (LSI) that performs error correction in the receiver includes the TS, a TS clock signal that indicates the timing of the TS, and the like.

Incidentally, the TS and the like that is output from the LSI, which performs error correction, are supplied to a module (hereinafter, also referred to as a TS processing module) that receives the TS and the like and that is connected to a subsequent stage of the LSI. Accordingly, the LSI, which performs error correction, needs to output a TS and the like that meet the specifications that the TS processing module connected to the subsequent stage can accept.

Standards specifying the interface of a TS processing module includes, for example, Digital Video Broadcasting-Common Interface Plus (DVB-CI Plus) (Non-Patent Literature 1).

In the DVB-CI Plus standard, “K.1.7.5 Common Interface MPEG Signal Timing” specifies the specifications of the TS clock signal.

Now, the specifications of the TS clock signal specified in the DVB-CI Plus standard may, hereinafter, also be referred to as AC specifications (AC spec).

### CITATION LIST

### Patent Literature

Non-Patent Literature 1: CI Plus Specification v1.3.1 (2011-10)

### SUMMARY OF INVENTION

### Technical Problem

Incidentally, when a jitter is generated in the TS clock signal, there are cases in which the TS clock signal fails to meet the specifications, such as the AC spec, that is required by the TS processing module of the subsequent stage.

The present technique has been conceived in view of the above situation and enables signals, such as a TS clock signal, that meet specifications required by a module of a subsequent stage to be output.

### Solution to Problem

According to an aspect of the present technology, there is provided a signal processing device, including a clock width calculation unit configured to calculate a clock width corresponding to a data rate of a valid section in which a transport stream (TS) packet exists, and a generation unit configured to generate a clock signal whose period is the clock width calculated in the clock width calculation unit and to output the clock signal as a shaped TS clock signal, the shaped TS clock signal being a TS clock signal of the TS packet to which shaping has been performed.

According to another aspect of the present technology, there is provided a signal processing method, including a clock width calculation step of calculating a clock width corresponding to a data rate of a valid section in which a transport stream (TS) packet exists, and a generating step of generating a clock signal whose period is the clock width calculated in the clock width calculation step and outputting the clock signal as a shaped TS clock signal, the shaped TS clock signal being a TS clock signal of the TS packet to which shaping has been performed.

In one aspect of the present technique, a clock width corresponding to a data rate of a valid section in which a transport stream (TS) packet exists is calculated. Moreover, a clock signal whose period is the above clock width is generated and is output as a shaped TS clock signal that is a TS clock signal of the TS packet to which shaping has been performed.

Note that the signal processing device may be an individual device or may be an internal block of an individual device.

### Advantageous Effects of Invention

According to the present technique, signals such as a TS clock signal that meet the specifications required by a module of a subsequent stage can be output.

### BRIEF DESCRIPTION OF DRAWINGS

FIG. 1 is a block diagram illustrating an exemplary configuration of a receiving system to which the present technique is applied.

FIG. 2 is a diagram illustrating exemplary signals that an FEC unit 22 outputs.

FIG. 3 is a block diagram illustrating another exemplary configuration of a receiving system to which the present technique is applied.

FIG. 4 is a diagram for describing the AC spec.

FIG. 5 is a block diagram illustrating an exemplary configuration of an embodiment of a receiving system to which a signal processing device according to the present technique is applied.

FIG. 6 is a block diagram illustrating an exemplary configuration of a smoothing unit 40.

FIG. 7 is a timing chart illustrating an operation of the smoothing unit 40.

FIG. 8 is a flowchart for describing a calculation process of a clock width Nint performed by a clock width calculation unit 55.

FIG. 9 is a block diagram illustrating an exemplary configuration of an embodiment of a computer to which the present technique is applied.

### DESCRIPTION OF EMBODIMENTS

### [A Receiving System to Which the Present Technique is Applied]

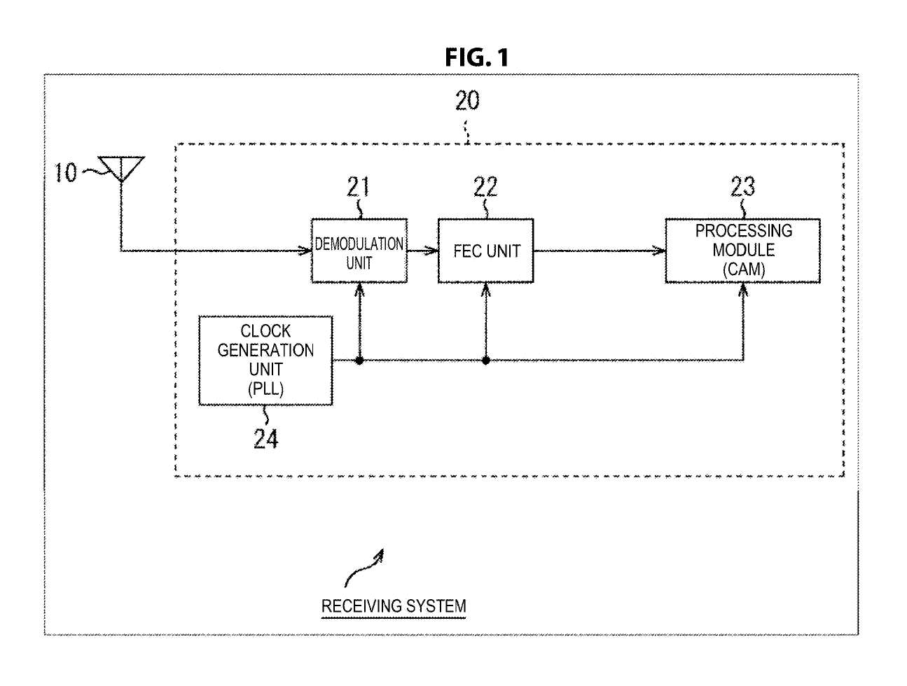

FIG. 1 is a block diagram illustrating an exemplary configuration of a receiving system to which the present technique is applied.

The receiving system of FIG. 1 receives digital broadcasting, for example.

In other words, in FIG. 1, the receiving system includes an antenna 10 and a receiver 20.

The antenna 10, for example, receives a broadcast wave of digital broadcasting including a TS and supplies the received signal resulting from the reception to the receiver 20.

The receiver 20 restores and processes the TS from the received signal that is from the antenna 10.

In other words, the receiver 20 includes a demodulation unit 21, a forward error correction (FEC) unit 22, a processing module 23, and a clock generation unit 24.

The demodulation unit 21 demodulates the received signal that is from the antenna 10 and supplies the resulting demodulated signal to the FEC unit 22.

The FEC unit 22 performs error correction on the demodulated signal that is from the demodulation unit 21 and supplies the resulting signal such as a TS to the processing module 23.

The processing module 23 is a TS processing module that performs processing on the TS.

Now, as regards the TS processing module, there is a module such as a conditional access module (CAM) that performs descrambling and the like on the TS and that is attachable and detachable to and from the receiver 20. When the processing module 23 is a CAM, signals such as the TS that are output from the FEC unit 22 needs to meet the AC spec and the like that is specified by the DVB-CI Plus standard.

The clock generation unit 24 is, for example, constituted by a phase lock loop (PLL) and generates an operating clock signal, which is a clock signal for operating the demodulation unit 21, the FEC unit 22, and the processing module 23 that constitute the receiver 20, and supplies the operating clock signal to the demodulation unit 21, the FEC unit 22, and the processing module 23. The demodulation unit 21, the FEC unit 22, and the processing module 23 operate according to the operating clock signal supplied from the clock generation unit 24.

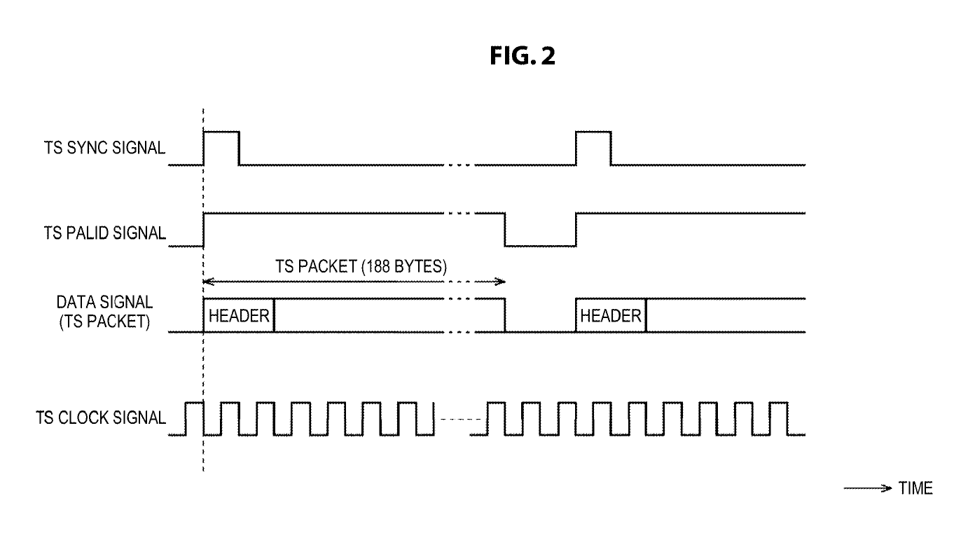

FIG. 2 is a diagram illustrating exemplary signals that the FEC unit 22 outputs.

FEC unit 22 outputs a TS sync signal, a TS valid signal, a data signal, and a TS clock signal.

The TS sync signal indicates the timing of the head of each TS packet included in the TS. The TS sync signal, for example, temporarily turns into level H (High) from level L (Low) only at the timing of the head of each TS packet.

The TS valid signal indicates sections (valid sections) in the TS in which the TS packets exist. The TS valid signal, for example, turns into level H in the valid sections and turns into level L in sections other than the valid sections. In other words, the TS valid signal turns into level H in the sections between the head to the end of each TS packet and turns into level L at other sections.

The data signal is a signal of the TS and includes the TS packets. The TS packets are each a packet having a data length (a packet length) of 188 bytes, the first 4 bytes of which are headers.

The TS clock signal is a signal indicating the timings of the data constituting the TS. The TS clock signal is a pulse-like signal that alternates between level L and level H.

For example, if, at this moment, the FEC unit 22 outputs TS packets (data signal) in parallel in units of 8 bits (parallel), a single period of a TS clock signal (a single pulse of the TS clock signal) will indicate an 8-bit timing of the TS packets that are output in parallel from the FEC unit 22.

Note that other than the TS (data signal), the TS sync signal and the TS valid signal are also signals that have been synchronized with the TS clock signal.

In other words, the TS sync signal and the TS valid signal are both signals whose level changes according to the timing of the falling edge of the TS clock signal, for example.

Now, since the FEC unit 22 operates in accordance with the operating clock signal generated by the clock generation unit 24, either of the TS sync signal, the TS valid signal, the data signal, and the TS clock signal are signals that are synchronized with the operating clock signal generated by the clock generation unit 24 (a signal whose level changes in accordance with the timing of the edge of the operating clock signal and in which the minimum granularity of the level change is the period of the operating clock signal).

While the FEC unit 22 outputs the TS sync signal, the TS valid signal, the data signal, and the TS clock signal that are described above, there are cases in which the TS clock signal does not meet the AC spec required by the processing module 23 of the subsequent stage when a jitter is generated in the TS clock signal output from the FEC unit 22.

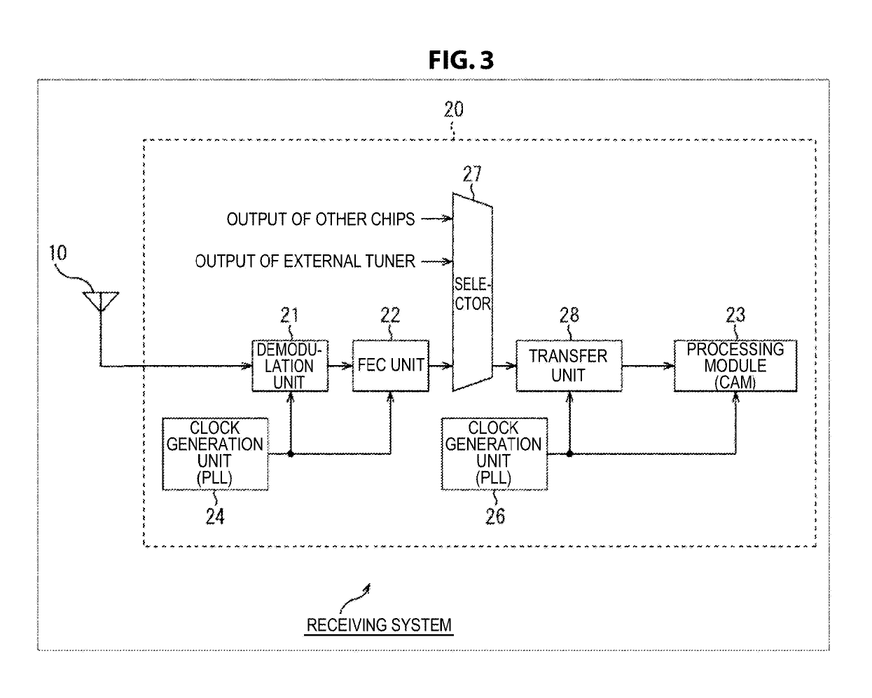

FIG. 3 is a block diagram illustrating another exemplary configuration of a receiving system to which the present technique is applied.

Note that in the drawing, portions that correspond to FIG. 1 are attached with the same reference numerals and, hereinafter, descriptions thereof are omitted as appropriate.

The receiving system of FIG. 3 is different from that of FIG. 1 in that the receiver 20 is additionally provided with a clock generation unit 26, a selector 27, and a transfer unit 28.

Similar to the clock generation unit 24, for example, the clock generation unit 26 is constituted by a PLL, generates an operating clock signal for operating the processing module 23 and the transfer unit 28, and supplies the generated operating clock signal to the processing module 23 and the transfer unit 28.

Accordingly, in FIG. 3, the demodulation unit 21 and the FEC unit 22 operate according to the operating clock signal generated by the clock generation unit 24, and the processing module 23 and the transfer unit 28 operate according to the operating clock signal generated by the clock generation unit 26.

In other words, in FIG. 3, the demodulation unit 21 and the FEC unit 22 operate according to an operating clock signal that is different from the operating clock signal of the processing module 23 and the transfer unit 28.

Note that the demodulation unit 21, the FEC unit 22, the processing module 23, and the transfer unit 28 may all be operated according to the same operating clock signal.

The TS sync signal, the TS valid signal, the data signal, and the TS clock signal that are output signals output from the FEC unit 22 are supplied to the selector 27. A TS sync signal, a TS valid signal, a data signal, and a TS clock signal that are output signals output from the external tuner (not shown) and TS sync signals, TS valid signals, data signals, and TS clock signals that are output signals output from other chips (not shown) are further supplied to the selector 27.

The selector 27 selects either one of the output signal of the FEC unit 22, the output signal of the external tuner, and the output signals of the other chips in accordance with, for example, an operation of a user and supplies the selected output signal to the transfer unit 28.

The transfer unit 28 transfers the clock signal of the output signal supplied from the selector 27 and supplies the output signal to the processing module 23.

In other words, the FEC unit 22, the external tuner, and the other chips that supply output signals to the selector 27 are constituted by chips (LSIs) that are separate from the processing module 23 and operate according to an operating clock signal that is asynchronous with the operating clock signal of the processing module 23 (the operating clock signal generated by the clock generation unit 26).

Accordingly, since the output signals output from the FEC unit 22, the external tuner, and the other chips do not synchronize with the operating clock signal of the processing module 23, in order to perform processing of the output signal with the processing module 23, transfer of the clock signal needs to be performed such that the output signal is transferred to a signal that synchronizes with the operating clock signal of the processing module 23.

To transfer the clock signal, the transfer unit 28 latches the output signal, which is supplied from the selector 27, according to the timing of the operating clock signal of the processing module 23 (the operating clock signal generated by the clock generation unit 26) such that the output signal is transformed into a signal (a signal whose level changes according to the timing of the edge of the operating clock signal of the processing module 23) that is in synchronization with the operating clock signal of the processing module 23 and supplies the transformed signal to the processing module 23.

As described above, in the transfer unit 28, the output signal supplied from the selector 27 is latched on the basis of the operating clock signal of the processing module 23 (the operating clock signal generated by the clock generation unit 26) that is asynchronous with the operating clock signal of the output signal.

As a result, a jitter is generated in the output signal output by the transfer unit 28.

Accordingly, even if the output signals output by the FEC unit 22, the external tuner, and the other chips meet the AC spec specified in the DVB-CI Plus standard, there are cases in which the output signal output by the transfer unit 28, in other words, the output signal after being transformed into the operating clock signal generated by the clock generation unit 26, do not meet the AC spec.

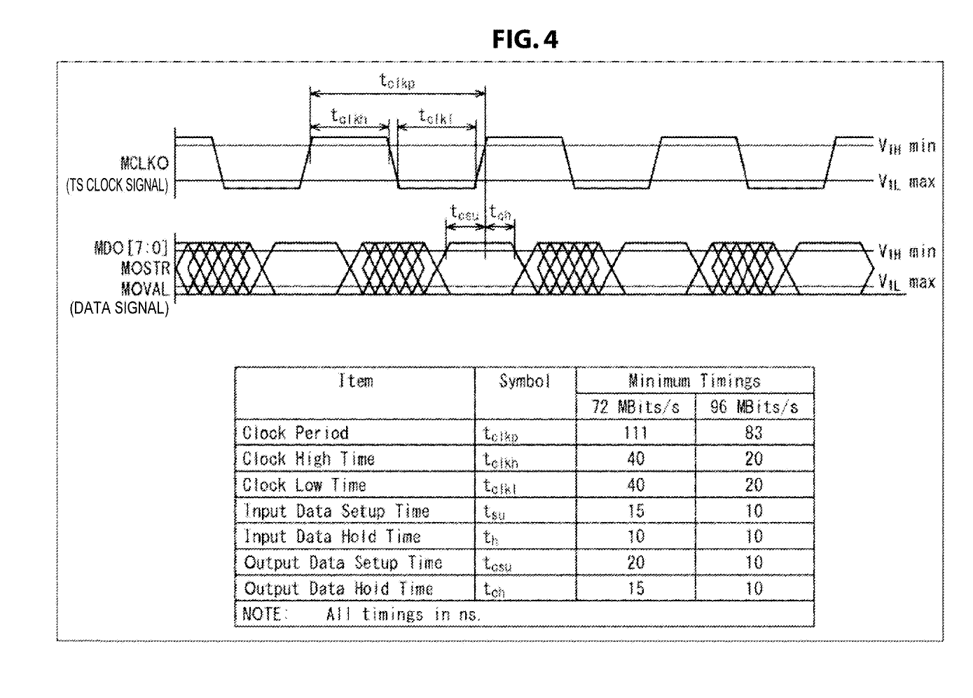

FIG. 4 is a diagram for describing the AC spec.

Referring to FIG. 4, T_{clkp} is the smallest clock width of the TS clock signal, in other words, T_{clkp} indicates a minimum clock width that is the minimum time value from a rising edge (falling edge) to the next rising edge (falling edge).

Furthermore, T_{clkh} indicates a minimum H level section, which is the minimum value of the level H section (time) of the TS clock signal (of a single period), and T_{clk1} indicates a minimum level L section, which is a minimum value of the level L section of the TS clock signal.

The AC spec specifies 96 Mbps and 72 Mbps as the upper limit of the bit rate of the TS, and the minimum clock width T_{clkp}, the minimum level H section T_{clkh}, and the minimum level L section T_{clk1} are each specified separately for (a TS of) 96 Mbps or lower and for (a TS of) 72 Mbps or lower.

In other words, it is specified that when lower than or equal to 96 Mbps, the minimum clock width T_{clkp} needs to be 83 nano seconds (ns) or longer, and the minimum level H section T_{clkh} and the minimum level L section T_{clk1} both need to be 20 ns or longer.

Furthermore, it is specified that when lower than or equal to 72 Mbps, the minimum clock width T_{clkp} needs to be 111 ns or longer, and the minimum level H section T_{clkh} and the minimum level L section T_{clk1} both need to be 40 ns or longer.

Now, when the TS packets are output in parallel in units of 8 bits (parallel) as described in FIG. 2 and when the data rate of the TS is 96 Mbps, the clock width (period) of the TS clock signal that indicates the timing of the TS packet in units of 8 bits needs to be 1/(96 Mbps/8 bits)=83.333 . . . ns or shorter.

Furthermore, when the data rate of the TS is 72 Mbps, the clock width of the TS clock signal needs to be 1/(72 Mbps/8 bits)=111.111 . . . ns or shorter.

As described above, 83.333 . . . ns and 111.111 . . . ns that are the clock widths that are physically required in the TS clock signal are extremely close to 83 ns and 111 ns that are the minimum clock width T_{clkp} required in the AC spec.

Accordingly, when a jitter is generated in the output signal to which transfer of the clock signal has been performed, the clock width of the TS clock signal included in the output signal becomes shorter than 83 ns and 111 ns that are specified in the AC spec as the minimum clock width T_{clkp} rendering it difficult to meet the AC spec.

### [An Embodiment of the Receiving System to Which the Present Technique is Applied]

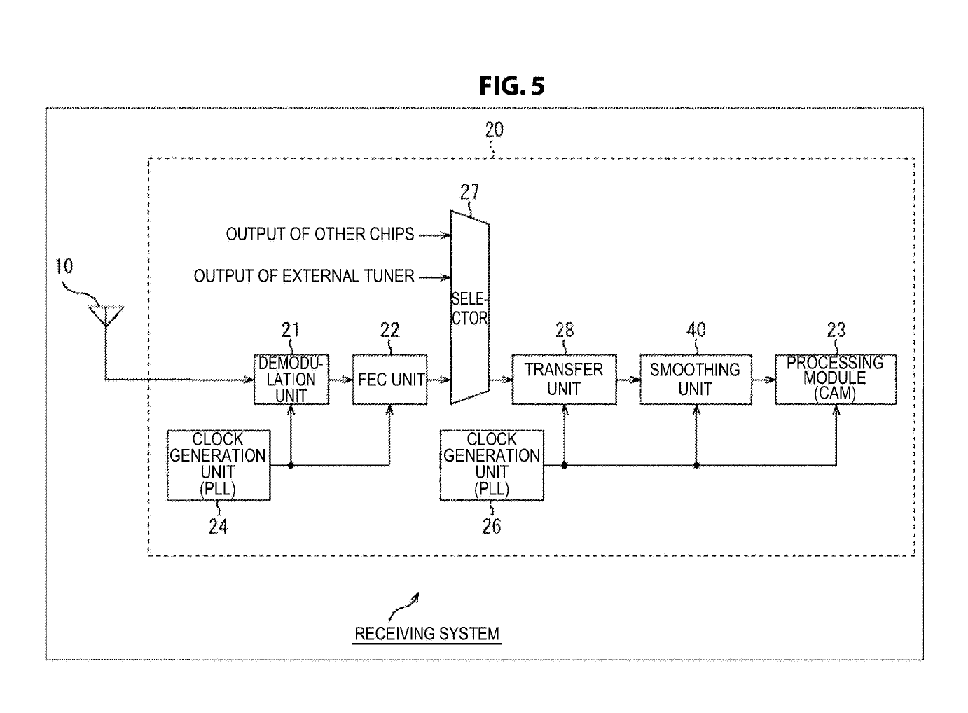

Now, FIG. 5 is a block diagram illustrating an exemplary configuration of an embodiment of a receiving system to which a signal processing device according to the present technique is applied.

Note that in the drawing, portions that correspond to FIG. 3 are attached with the same reference numerals and, hereinafter, descriptions thereof are omitted.

The receiving system of FIG. 5 is the same as that of FIG. 3 in that the antenna 10, the demodulation unit 21, the FEC unit 22, the processing module 23, the clock generation units 24 and 26, the selector 27, and the transfer unit 28 are included.

However, different from the receiving system of FIG. 3 that includes no smoothing unit 40, the receiving system of FIG. 5 includes a smoothing unit 40.

Similar to the processing module 23 and the transfer unit 28, the smoothing unit 40 operates in accordance with the operating clock signal generated by the clock generation unit 26.

An output signal to which transfer of the clock signal has been performed is supplied to the smoothing unit 40 from the transfer unit 28.

The smoothing unit 40 generates a clock signal, the period of which is uniformized by smoothing the TS clock signal included in the output signal that is from the transfer unit 28, as a shaped TS clock signal that is a TS clock signal to which shaping has been performed.

Moreover, together with the shaped TS clock signal, the smoothing unit 40 supplies, to the processing module 23, the signals that are in synchronization with the shaped TS clock signal, namely, the TS (data signal), the TS sync signal, and the TS valid signal that are included in the output signal that is from the transfer unit 28.

### [An Exemplary Configuration of the Smoothing Unit 40]

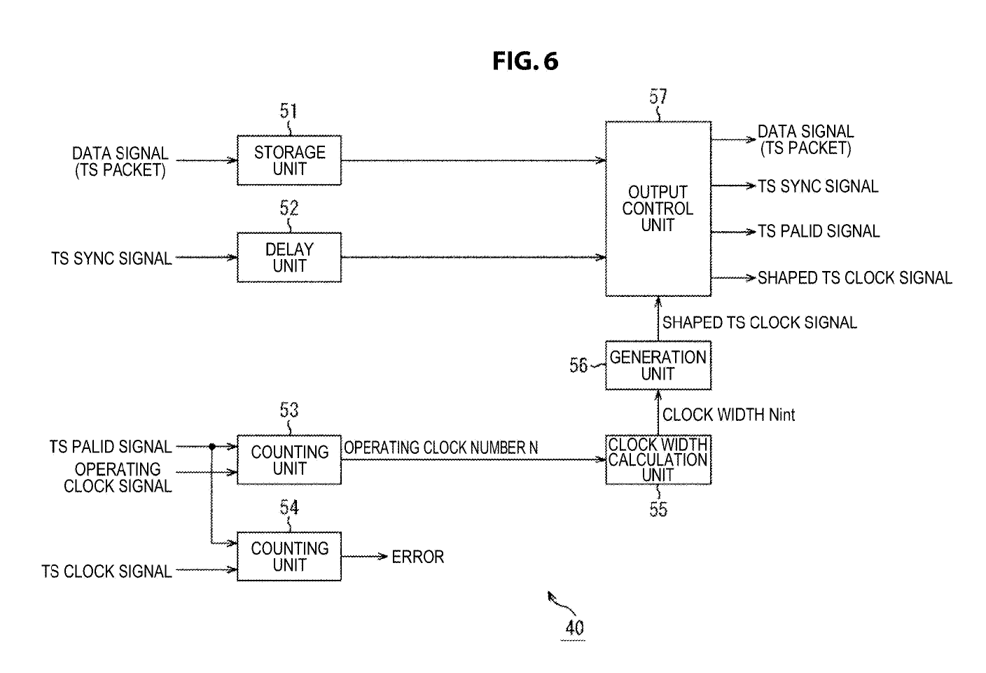

FIG. 6 is a block diagram illustrating an exemplary configuration of the smoothing unit 40 of FIG. 5.

Referring to FIG. 6, the smoothing unit 40 includes a storage unit 51, a delay unit 52, counting units 53 and 54, a clock width calculation unit 55, a generation unit 56, and an output control unit 57.

A data signal (TS) included in the output signals that is from the transfer unit 28 is supplied to the storage unit 51.

The storage unit 51 temporarily stores the data signal (TS) that is from the transfer unit 28.

A TS sync signal included in the output signals that are from the transfer unit 28 is supplied to the delay unit 52.

The delay unit 52 delays the TS sync signal that is from the transfer unit 28 and supplies the delayed TS sync signal to the output control unit 57.

In other words, the delay unit 52 delays a pulse indicating the head of a TS packet serving as a TS sync signal that is from the transfer unit 28 by a certain amount of time, that is, until the timing of the head of the next TS packet, and supplies the delayed TS sync signal to the output control unit 57.

The counting unit 53 is provided with a TS valid signal included in the output signals that are from the transfer unit 28 as well as the operating clock signal generated in the clock generation unit 26.

The counting unit 53 detects the valid section in the data signal (TS) in which the TS packet exists from the TS valid signal that is from the transfer unit 28 and counts a clock number (the number of rising edges or the number of falling edges) (hereinafter, also referred to as a valid operating clock number) N of the operating clock signal in the valid section generated in the clock generation unit 26.

Moreover, the counting unit 53 supplies the valid operating clock number N to the clock width calculation unit 55.

The TS valid signal and the TS clock signals that are included in the output signals that are from the transfer unit 28 are supplied to the counting unit 54.

The counting unit 54 detects the valid section from the TS valid signal that is from the transfer unit 28 and counts the clock number (hereinafter, also referred to as a valid TS clock number) of the TS clock signal, which is from the transfer unit 28, in the valid section.

Moreover, when the valid TS clock number (the count value of the number of clocks in the TS clock signal in the valid section) is below 188 bytes, which is the data length of the TS packet, the counting unit 54 outputs an error message implying that there is an abnormality in the data length of the TS packet.

The clock width calculation unit 55 calculates a clock width Nint that corresponds to the data rate of the valid section of the TS by using the valid operating clock number N that is from the counting unit 53.

In other words, the clock width calculation unit 55 obtains, as the clock width Nint, an integer that is smaller than or equal to a value (hereinafter, also referred to as a byte clock number) N/188 that is a quotient of the valid operating clock number N, which is from the counting unit 53, divided by 188 bytes, which is the data length of the TS packet.

Now, since the byte clock number N/188 is a reciprocal of the data rate of the TS packet and corresponds to the data rate of the TS packet, it can be said that the clock width Nint, which is an integer that is smaller than or equal to the byte clock number N/188, corresponds to the data rate of (the valid section of) the TS packet.

Note that the unit of Nint that indicates the clock width is the clock number of the operating clock signal generated in the clock generation unit 26 (hereinafter, also referred to as merely an operating clock signal). Accordingly, by multiplying Nint by the amount of time that is a period of the operating clock signal, a clock width based on a unit of time can be obtained.

Furthermore, in the clock width calculation unit 55, (a clock number that corresponds to) the amount of time that is greater than or equal to the minimum clock width T_{clkp} of the AC spec is calculated as the clock width Nint.

The clock width calculation unit 55 supplies the clock width Nint to the generation unit 56.

The generation unit 56 generates a pulse-like clock signal whose period is the clock width Nint that has been calculated in the clock width calculation unit 44 and outputs the pulse-like clock signal to the output control unit 57 as a shaped TS clock signal that is a TS clock signal of the TS packet to which shaping has been performed.

The output control unit 57 synchronizes with the shaped TS clock signal from the generation unit 56 and performs an output control that outputs the data signals (TS) stored in the storage unit 51 and the TS sync signals that have been delayed in the delay unit 52 to the processing module 23 (FIG. 5).

Furthermore, the output control unit 57 performs an output control that generates, from the rising edge of the TS sync signal, a TS valid signal in which the section amounting to 188 clocks of the shaped TS clock signal is level H and outputs the TS valid signal to the processing module 23.

Note that, when the counting unit 54 outputs an error message implying that there is an abnormality in the data length of the TS packet, the output control unit 57 discards (deletes) the TS packet having an abnormality in the data length that is included in the data signal stored in the storage unit 51 without outputting the abnormal TS packet.

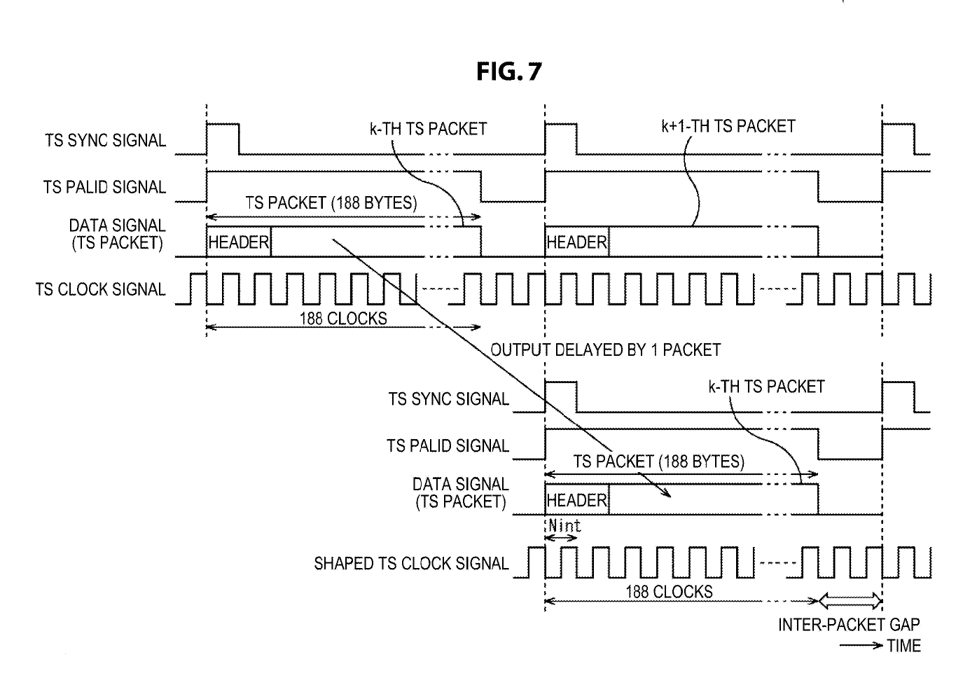

FIG. 7 is a timing chart for describing an operation of the smoothing unit 40 of FIG. 6.

In other words, FIG. 7 is a diagram illustrating the TS sync signal, the TS valid signal, the data signal, and the TS clock signal that are output signals to which transfer of the clock signals have been performed and that are supplied from the transfer unit 28 to the smoothing unit 40 (the upper side of FIG. 7) and the TS sync signal, the TS valid signal, the data signal, and the shaped TS clock signal that are output signals output from the smoothing unit 40 (the lower side of FIG. 7).

The smoothing unit 40 delays the output signals that are from the transfer unit 28 to which transfer of the clock signals have been performed by an amount of time equal to a single packet while performing the required processing, and outputs the delayed signals.

Now, when attention is given to a k-th TS packet of the data signals (TS) included in the output signals to which transfer of the clock signals have been performed and when assuming that the output signal of the k-th TS packet is supplied to the smoothing unit 40 from the transfer unit 28, the k-th TS packet (data signal) that is supplied from the transfer unit 28 to the smoothing unit 40 is temporarily stored in the storage unit 51.

Furthermore, the TS sync signal of the k-th TS packet that is supplied from the transfer unit 28 is delayed in the delay unit 52.

Moreover, the counting unit 53 detects the valid section of the k-th TS packet from the TS valid signal of the k-th TS packet that is supplied from the transfer unit 28. Then, the counting unit 53 counts the clock number N of the operating clock signal in the valid section of the k-th TS packet and supplies the counted clock number N as a valid operating clock number N to the clock width calculation unit 55.

The clock width calculation unit 55 obtains the byte clock number N/188 that is a quotient of the valid operating clock number N, which is from the counting unit 53, divided by 188 bytes, which is the data length of the TS packet, and, for example, calculates the maximum integer smaller than or equal to the byte clock number N/188 (a value of the byte clock number N/188 rounded down to an integer), for example, as the clock width Nint.

When the output signal regarding the k-th TS packet is supplied to the smoothing unit 40 from the transfer unit 28 and when the clock width Nint is calculated in the clock width calculation unit 55, the generation unit 56 generates a pulse-like clock signal whose period is the clock width Nint that has been calculated in the clock width calculation unit 44 and outputs the pulse-like clock signal to the output control unit 57 as a shaped TS clock signal that is a TS clock signal of the k-th TS packet to which shaping has been performed.

When the delay unit 52, for example, is supplied with a TS sync signal that corresponds to the head of the next TS packet (the k+1-th TS packet), the output control unit 57 outputs the k-th TS packet (digital signal), the TS sync signal, the TS valid signal, and the shaped TS clock signal to the processing module 23 (FIG. 5).

In other words, the output control unit 57 starts outputting the TS sync signal of the k-th TS packet that had been delayed by the delay unit 52.

Furthermore, the output control unit 57 starts outputting the shaped TS clock signal generated in the generation unit 56 at a timing in which the timing of the rising edge of the TS sync signal of the k-th TS packet synchronizes with the falling edge of the shaped TS clock signal of the k-th TS packet generated in the generation unit 56.

Moreover, the output control unit 57 synchronizes with the shaped TS clock signal and outputs the k-th TS packet (data signal) that has been stored in the storage unit 51.

Furthermore, from the rising edge of the TS sync signal of the k-th TS packet, the output control unit 57 generates, as a TS valid signal of the k-th TS packet, a signal (a pulse) in which the section amounting to 188 clocks of the shaped TS clock signal of the k-th TS packet is level H and outputs the TS valid signal.

Note that the counting unit 54 counts the clock number (the valid TS clock number) of the TS clock signal of the k-th TS packet in the valid section of the k-th TS packet and outputs an error message implying that there is an abnormality in the data length of the TS packet when the valid TS clock number is below 188 bytes that is the data length of the TS packet.

When the counting unit 54 outputs an error message implying that there is an abnormality in the data length of the TS packet, the output control unit 57 discards (deletes) the k-th TS packet without outputting the k-th TS packet stored in the storage unit 51. In such a case, the output control unit 57 may output a NULL packet, for example, as the k-th TS packet.

Furthermore, the output control unit 57 continues outputting the shaped TS clock signal of the k-th TS packet also after the valid time interval of the k-th TS packet has ended (after the timing of the falling edge of the TS valid signal of the k-th TS packet) until the output of the output signal regarding the k+1-th TS packet, which is the next TS packet, starts (until the output of the k+1-th TS packet starts).

Note that a section from the end of the valid time interval of the TS packet to the head of the next TS packet may also be referred to as an inter-packet gap.

As described above, the output control unit 57 outputs the shaped TS clock signal not only in the valid section but also in the inter-packet gap.

As an alternative of the (maximum) integer smaller than or equal to the byte clock number N/188, the clock width calculation unit 55 may calculate an integer (the maximum integer, for example) that is smaller than or equal to a value that is a product of the byte clock number N/188 multiplied by a coefficient (hereinafter, also referred to as a quick calculation rate) that is a positive number below 1 as the clock width Nint.

The smaller the quick calculation rate is set, the smaller the clock width Nint becomes and the data rate (the data rate of the valid section) of the TS packet output in synchronization with the shaped TS clock signal having the clock width Nint becomes faster. Accordingly, the smaller the quick calculation rate is set, the earlier the output of the TS packet from (the output control unit 57 of) the smoothing unit 40 ends, and, as a result, an inter-packet gap with a longer time can be obtained.

As described above, when an integer smaller than or equal to a value that is a product of the byte clock number N/188 multiplied by the quick calculation rate is calculated as the clock width Nint, an inter-packet gap having a length (an amount of time) corresponding to the quick calculation rate can be obtained; accordingly, when the processing module 23 (FIG. 5) requests for an inter-packet gap (an invalid data section), the request can be answered.

Note that when the processing module 23 requests for an inter-packet gap, the clock width calculation unit 55 may calculate the clock width Nint using the quick calculation rate.

### [Calculation of the Clock Width Nint]

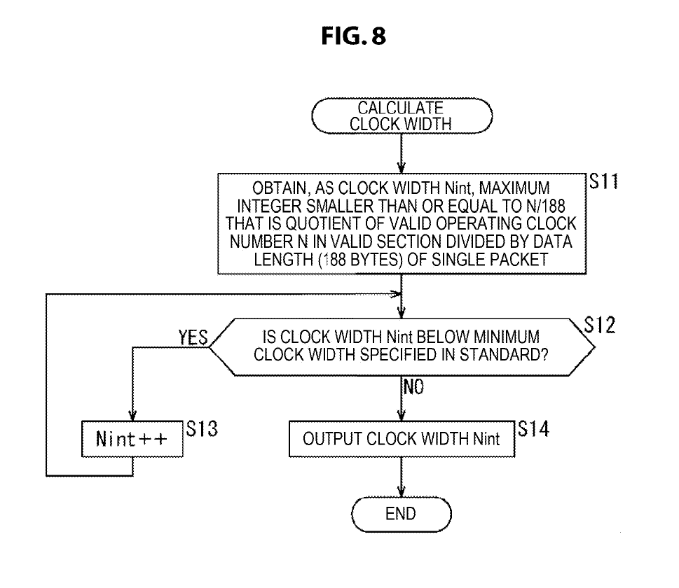

FIG. 8 is a flowchart for describing a calculation process of the clock width Nint performed by the clock width calculation unit 55 of FIG. 6.

In step S11, the clock width calculation unit 55 obtains the byte clock number N/188 that is a quotient of the valid operating clock number N, which is supplied from the counting unit 53, divided by 188 bytes, which is the data length of the TS packet, and calculates the maximum integer smaller than or equal to the byte clock number N/188 as the clock width Nint.

Note that in step S11, as described above, the maximum integer smaller than or equal to the value that is the product of the byte clock number N/188 multiplied by the quick calculation rate may be alternatively calculated as the clock width Nint.

After step S11, the process proceeds to step S12 and the clock width calculation unit 55 determines whether the clock width Nint is below, for example, the minimum clock width T_{clkp} specified in the AC spec, which the processing module 23 needs to satisfy.

In step S12, when the clock width Nint is determined to be below the minimum clock width T_{clkp}, the process proceeds to step S13 and the clock width calculation unit 55 increments the clock width Nint by 1.

Note that, as described in FIG. 6, the unit of the clock width Nint is the clock number of the operating clock signal generated in the clock generation unit 26. Accordingly, when converted into the amount of time, incrementing the clock width Nint by 1 corresponds to incrementing the amount of time equal to the period of the operating clock signal.

After step S13, the process returns to step S12 and, thereafter, similar processes are repeated.

Moreover, when the clock width Nint is determined that it is not below the minimum clock width T_{clkp} in step S12, the process proceeds to step S14, and the clock width calculation unit 55 outputs the clock width Nint to the generation unit 56 and ends the process.

The generation unit 56 operates in accordance with the operating clock signal generated in the clock generation unit 26 and generates, as a shaped TS clock signal, a pulse-like clock signal whose period is the clock width Nint that is from the clock width calculation unit 55.

As described above, since the maximum integer smaller than or equal to the byte clock number N/188, the byte clock number N/188 being the number (valid operating clock number) N of operating clocks in the valid section divided by the data length (188 bytes) of the TS packet, is calculated as the clock width Nint of the shaped TS clock signal, which is a TS clock signal, in which a jitter is generated, to which shaping has been performed, the clock width Nint becomes the averaged (smoothed) value of the clock width of the TS clock signal in which a jitter has been generated.

Accordingly, the shaped TS clock signal becomes (has an extremely high possibility of being) a signal meeting the AC spec required for the output signal supplied to the processing module 23.

In other words, referring to FIG. 5, if there is a possibility of the output signals of the FEC unit 22, the external tuner, and the other chips being supplied to the processing module 23 that requires the signals to meet the AC spec, the FEC unit 22, the external tuner, and the other chips are mounted so that the output signals meet the AC spec.

Accordingly, even if, in the transfer unit 28, jitters are generated in the TS clock signals that meet the AC spec and that are output from the FEC unit 22, the external tuner, and the other chips, and even if the TS clock signals consequently fail to meet the AC spec, the degree to which the TS clock signals generated with jitters not meeting the AC spec is not that large.

Accordingly, the shaped TS clock signal having the clock width Nint that is the averaged clock width of the TS clock signal in which the degree of not meeting the AC spec is not that large meets the AC spec in most cases.

Note that in the present embodiment, by way of precaution, determination is performed on whether the clock width Nint is below the minimum clock width T_{clkp} specified in the AC spec. When the clock width Nint is below the minimum clock width T_{clkp}, the clock width Nint is corrected to the value larger than or equal to the minimum clock width T_{clkp} in the loop of steps S12 and S13 of FIG. 8. Accordingly, in the present embodiment, it is assured that the shaped TS clock signal having the clock width Nint meets the AC spec, in other words, the shaped TS clock signal having the clock width Nint is assured to be a signal having a clock width that is larger than or equal to the minimum clock width T_{clkp} specified in the AC spec.

The generation unit 56 generates the above-described pulse-like clock signal whose period is the clock width Nint as the shaped TS clock signal. As for the duty ratio of the shaped TS clock signal, 50% is adopted, for example.

In such a case, in a single period of the shaped TS clock signal, the length (amount of time) of the level H section that is at level H and the length of the level L section that is at level L are the same.

As described above, by adopting 50% for the duty ratio of the shaped TS clock signal, as long as the clock width Nint of the shaped TS clock signal is larger than or equal to the minimum clock width T_{clkp} specified in the AC spec, the lengths of the level H section and the level L section of the shaped TS clock signal will be larger than or equal to the minimum level H section T_{clkh} and the minimum level L section T_{clk1}, respectively, that are specified in the AC spec.

In the AC spec, since the minimum level H section T_{clkh} and the minimum level LH section T_{clk1} are both values below 50% of the minimum clock width T_{clkp}, as long as the duty ratio of the shaped TS clock signal is 50% and the clock width Nint of the shaped TS clock signal is larger than or equal to the minimum clock width T_{clkp}, the lengths of the level H section and the level L section of the shaped TS clock signal will invariably be larger than or equal to the minimum level H section T_{clkh} and the minimum level L section T_{clk1}, respectively.

Accordingly, if the clock width Nint of the shaped TS clock signal is verified (determined) to be larger than or equal to the minimum clock width T_{clkp}, there will be no need to verify whether the lengths of the level H section and the level L section of the shaped TS clock signal are larger than or equal to the minimum level H section T_{clkh} and the minimum level L section T_{clk1}, respectively.

Note that the storage capacity of the storage unit 51 depends on the extent to which the jitter is generated in the transfer unit 28. If, in the output signals to which transfer of the clock signal have been performed in the transfer unit 28, the valid time interval is the same and a jitter is only generated in the TS clock signal, the storage unit 51 will be able to use a memory with a storage capacity amounting to a single packet.

As described above, the smoothing unit 40 calculates the clock width Nint corresponding to the data rate of the valid section in which the TS packet exists, generates a clock signal, whose period is the clock width Nint, as a shaped TS clock signal that is a TS clock signal of the TS packet to which shaping has been performed, and outputs the shaped TS clock signal to the processing module 23 of the subsequent stage; accordingly, even if a jitter is generated in the TS clock signal and even if the TS clock signal does not meet the specifications (hereinafter, also referred to as input specifications) required by the processing module 23, if the degree of the TS clock signal, in which jitters are generated, not meeting the input specifications is not that large, the shaped TS clock signal becomes a signal that meets the input specifications.

Accordingly, the smoothing unit 40 can output a signal that meets the specifications (input specifications) required by the processing module 23 of the subsequent stage.

Note that in the present embodiment, while a description has been given in which the TS packet is output to the processing module 23 in parallel in units of 8 bits (parallel), the present technique may be applied to other cases, for example, a case in which the TS packet is output in series in units of a single bit.

Furthermore, the receiving system of FIG. 5 is a receiving system of FIG. 3 provided with the smoothing unit 40; however, the receiving system to which the present technique is applied may adopt other configurations such as, for example, a receiving system of FIG. 1 provided with the smoothing unit 40.

Furthermore, the standard (specifications) that the signal that is supplied to the processing module 23 needs to meet is not limited to (the AC spec of) the DVB-CI Plus standard and any standard may be adopted.

Additionally, other than the receiver that receives digital broadcasting, the present technique may be applied to any device that transmits a packet such as a TS packet.

Furthermore, the stream subject to processing is not limited to a TS.

### [Description of a Computer to Which the Present Technique is Applied]

Now, among the above-described sequential process, at least a portion of the process may be implemented by hardware or may be implemented by software. When the process is implemented by software, a program constituting the software is installed on a general purpose computer or the like.

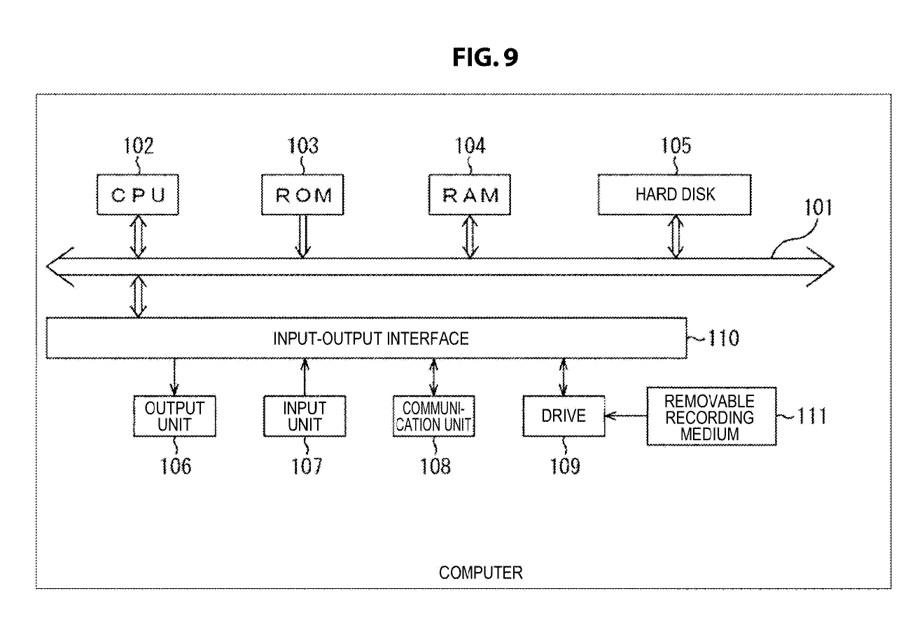

Now, FIG. 9 illustrates an exemplary configuration of an embodiment of a computer on which a program executing the processing is installed.

The program may be prerecorded on a hard disk 105 or in a ROM 103 serving as a recording medium built in the computer.

Furthermore, the program may be alternatively stored (recorded) in a removable recording medium 111. Such a removable recording medium 111 may be provided as a so-called packaged software. Now, the removable recording medium 111 includes, for example, a flexible disk, a compact disc read-only memory (CD-ROM), a magneto-optical (MO) disk, a digital versatile disc (DVD), a magnetic disk, and a semiconductor memory.

Note that other than being installed on the computer from a removable recording medium 111 described above, the program may be downloaded on the computer through a communication network or a broadcasting network and be installed on the built-in hard disk 105. In other words, the program may be, for example, transferred wirelessly to the computer from a download site through an artificial satellite for digital satellite broadcasting or may be transferred to the computer from a download site by cable through a network such as a local area network (LAN) or the Internet.

The computer is built in with a central processing unit (CPU) 102, and the CPU 102 is connected to an input-output interface 110 through a bus 101.

When a user, for example, operates an input unit 107 and a command is input through the input-output interface 110, the CPU 102 executes the program installed in the read only memory (ROM) 103 according to the command. Alternatively, the CPU 102 loads the program stored on the hard disk 105 into random access memory (RAM) 104 and executes the program.

Accordingly, the CPU 102 performs a process according to the flow chart described above or performs a process that is performed based on the configuration of the block diagram described above. Then, as required, the CPU 102 outputs from an output unit 106 or transmits from a communication unit 108 the processing result, or further, records the processing result on the hard disk 105 through the input-output interface 110, for example.

Note that the input unit 107 includes a keyboard, a mouse, a microphone, and the like. Furthermore, the output unit 106 includes a liquid crystal display (LCD), a speaker, and the like.

In addition, in the case where a plurality of processes is included in one step, the plurality of processes included in this one step can be executed by one apparatus or by allocating a plurality of apparatuses.

The program may be processed by one computer (processor) or by a plurality of computers in a distributed manner. Further, the program may be performed after being transferred to a remote computer.

Further, in the present disclosure, a system has the meaning of a set of a plurality of configured elements (such as an apparatus or a module (part)), and does not take into account whether or not all the configured elements are in the same casing. Therefore, the system may be either a plurality of apparatuses, stored in separate casings and connected through a network, or a plurality of modules within a single casing.

An embodiment of the disclosure is not limited to the embodiments described above, and various changes and modifications may be made without departing from the scope of the disclosure.

For example, the present disclosure can adopt a configuration of cloud computing which processes by allocating and connecting one function by a plurality of apparatuses through a network.

Further, each step described by the above mentioned flow charts can be executed by one apparatus or by allocating a plurality of apparatuses.

In addition, in the case where a plurality of processes is included in one step, the plurality of processes included in this one step can be executed by one apparatus or by allocating a plurality of apparatuses.

Note that the present technique may be configured as follows.

(1)

A signal processing device, including:

a clock width calculation unit configured to calculate a clock width corresponding to a data rate of a valid section in which a transport stream (TS) packet exists; and

a generation unit configured to generate a clock signal whose period is the clock width calculated in the clock width calculation unit and to output the clock signal as a shaped TS clock signal, the shaped TS clock signal being a TS clock signal of the TS packet to which shaping has been performed.

(2)

The signal processing device according to (1),

wherein the clock width calculation unit calculates, as the clock width, an integer that is smaller than or equal to a quotient of a valid operating clock number, the valid operating clock number being a counted number of predetermined operating clocks in the valid section, divided by a data length of the TS packet.

(3)

The signal processing device according to (2),

wherein the clock width calculation unit further calculates a clock width that is larger than or equal to a minimum period of the TS clock signal that is required by a module to which the TS packet and the shaped TS clock signal are supplied.

(4)

The signal processing device according to (2) or (3),

wherein the clock width calculation unit calculates, as the clock width, an integer that is smaller than or equal to a product of the quotient of the valid operating clock number divided by a packet length of the TS packet multiplied by a coefficient that is a positive number below 1, and

wherein, after an end of the valid section, the generation unit continues to output the shaped TS clock signal whose period is the clock width until a timing of a head of a next TS packet.

(5)

The signal processing device according to any one of (1) to (4), further including

an output control unit configured to synchronize with a shaped TS clock and to output the TS packet,

wherein, when there is an abnormality in the data length of the TS packet, the output control unit discards the TS packet without outputting the TS packet.

(6)

The signal processing device according to (5),

wherein, when a counted value that is a count of the TS clock signal in the valid section is below the data length of the TS packet, the data length of the TS packet is determined to be abnormal and the TS packet is discarded without outputting the TS packet.

(7)

A signal processing method, including:

a clock width calculation step of calculating a clock width corresponding to a data rate of a valid section in which a transport stream (TS) packet exists; and

a generating step of generating a clock signal whose period is the clock width calculated in the clock width calculation step and outputting the clock signal as a shaped TS clock signal, the shaped TS clock signal being a TS clock signal of the TS packet to which shaping has been performed.

### REFERENCE SIGNS LIST

10 antenna
20 receiver
21 demodulation unit
22 FEC unit
23 processing module
24, 26 clock generation unit
27 selector
28 transfer unit
40 smoothing unit
51 storage unit
52 delay unit
53, 54 counting unit
55 clock width calculation unit
56 generation unit
57 output control unit
101 bus
102 CPU
103 ROM
104 RAM
105 hard disk
106 output unit
107 input unit
108 communication unit
109 drive
110 input-output interface
111 removable recording medium.

1. A signal processing device, comprising:
a clock width calculation unit configured to calculate a clock width corresponding to a data rate of a valid section in which a transport stream (TS) packet exists; and
a generation unit configured to generate a clock signal whose period is the clock width calculated in the clock width calculation unit and to output the clock signal as a shaped TS clock signal, the shaped TS clock signal being a TS clock signal of the TS packet to which shaping has been performed.

2. The signal processing device according to claim 1,
wherein the clock width calculation unit calculates, as the clock width, an integer that is smaller than or equal to a quotient of a valid operating clock number, the valid operating clock number being a counted number of predetermined operating clocks in the valid section, divided by a data length of the TS packet.

3. The signal processing device according to claim 2,
wherein the clock width calculation unit further calculates a clock width that is larger than or equal to a minimum period of the TS clock signal that is required by a module to which the TS packet and the shaped TS clock signal are supplied.

4. The signal processing device according to claim 2,
wherein the clock width calculation unit calculates, as the clock width, an integer that is smaller than or equal to a product of the quotient of the valid operating clock number divided by a packet length of the TS packet multiplied by a coefficient that is a positive number below 1, and
wherein, after an end of the valid section, the generation unit continues to output the shaped TS clock signal whose period is the clock width until a timing of a head of a next TS packet.

5. The signal processing device according to claim 2, further comprising
an output control unit configured to synchronize with a shaped TS clock and to output the TS packet,
wherein, when there is an abnormality in the data length of the TS packet, the output control unit discards the TS packet without outputting the TS packet.

6. The signal processing device according to claim 5,
wherein, when a counted value that is a count of the TS clock signal in the valid section is below the data length of the TS packet, the data length of the TS packet is determined to be abnormal and the TS packet is discarded without outputting the TS packet.

7. A signal processing method, comprising:
a clock width calculation step of calculating a clock width corresponding to a data rate of a valid section in which a transport stream (TS) packet exists; and
a generating step of generating a clock signal whose period is the clock width calculated in the clock width calculation step and outputting the clock signal as a shaped TS clock signal, the shaped TS clock signal being a TS clock signal of the TS packet to which shaping has been performed.
